(19) United States
(12) Patent Application Publication
(10) Pub. No.: US 2005/0239016 A1
(43) Pub. Date: Oct. 27, 2005

(54) Apparatus for filtering dental solid waste

(76) Inventor: Charles McCary, Huntsville, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/111,618

(22) Filed: Apr. 21, 2005

Related U.S. Application Data
(60) Provisional application No. 60/564,334, filed on Apr. 22, 2004.

(51) Int. Cl. A61C 17/06

(52) U.S. Cl. 433/92

(57) ABSTRACT

An apparatus for filtering dental solid waste has been developed. The apparatus includes a high volume evacuation (HVE) tip with one end that is connected to a suction line and another end that is inserted in a patient's mouth to remove dental waste. A filtration unit is located within the HVE tip that retains solid dental waste within the HVE tip.

### CROSS-REFERENCE TO RELATED APPLICATIONS

This application claims priority from U.S. Provisional Application 60/564,334 entitled “Apparatus for Filtering Dental Solid Waste” that was filed on Apr. 22, 2004.

### BACKGROUND OF INVENTION

1. Field of the Invention

The invention relates generally to medical devices. More specifically, the invention relates to an apparatus for filtering dental solid waste.

2. Background Art

When filings in teeth are replaced or removed, the composition of the filings is often a mixture of such materials as silver, mercury, copper, zinc, tin, palladium, etc. These materials, along with other solid or semi-solid debris, pose disposal problems for dental facilities since they may contain hazardous and possibly bio-hazardous material.

Such material is typically removed from the patient's mouth by a high volume evacuation (HVE) tip as shown in FIG. 1. The HVE tip 10 is attached to a tube 12 with a vacuum that draws both liquid and solid material from the patient's mouth. A first filtration canister 14 is located at the patient's chair to provide an initial filtration to remove solid debris. A second filtration trap 16 is located further along the line before the vacuum pump 18. After the vacuum pump, the filtered liquid in disposed in the sewer.

The filtration canister and the filtration trap are each periodically cleaned by hand. This typically involves removed the filtration screen from the canister or trap and cleaning off the filtered debris. This is an unpleasant, messy and potentially dangerous process since the person responsible for the cleaning is exposed to these materials. Additionally, the filtered materials such as mercury must be disposed of properly since they cannot simply be added to the sewer or trash.

### SUMMARY OF INVENTION

In some aspects, the invention relates to an apparatus for filtering dental solid waste, comprising: a high volume evacuation (HVE) tip with a first end that is connected to a suction line and a second end that is inserted in a patient's mouth to remove dental waste; and a filtration unit that is located between the first end of the HVE tip and the second end of the HVE tip, where the filtration unit retains solid dental waste within the HVE tip.

In other aspects, the invention relates to an apparatus for filtering dental solid waste, comprising: a high volume evacuation (HVE) tip with a first end that is connected to a suction line and a second end that is inserted in a patient's mouth to remove dental waste; and means for filtering and retaining dental solid waste within the HVE tip.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of a prior art filtration system for dental solid waste.

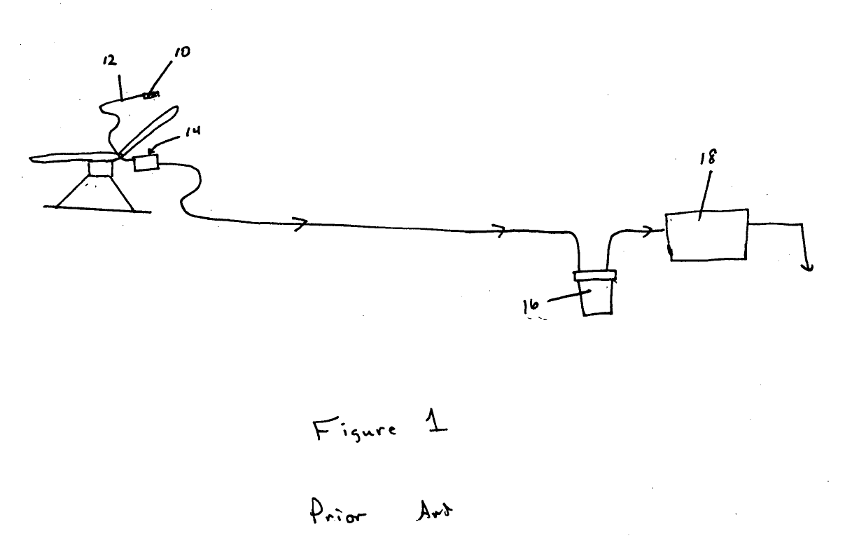

FIGS. 2a and 2b show perspective views of a High Volume Evacuation (HVE) tip both with and without a Saliva Ejector (SE) in accordance with one embodiment of the present invention.

FIGS. 3a-3c show top and cross-sectional views of a High Volume Evacuation (HVE) tip both with and without a Saliva Ejector (SE) in accordance with one embodiment of the present invention.

FIG. 4 shows a cross-sectional view of a High Volume Evacuation (HVE) tip in accordance with an alternative embodiment of the present invention.

FIGS. 5a and 5b show cross-sectional views of a High Volume Evacuation (HVE) tip in accordance with other alternative embodiments of the present invention.

FIGS. 6a-6c show cut-away views of a High Volume Evacuation (HVE) tip in accordance with other alternative embodiments of the present invention.

### DETAILED DESCRIPTION

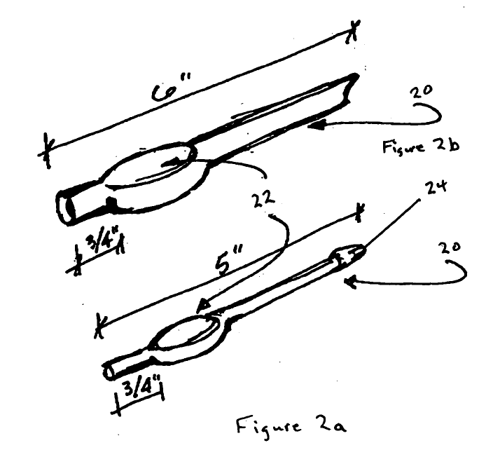

An apparatus to filter dental solid waste has been developed. FIGS. 2a and 2b shows perspective views of a High Volume Evacuation (HVE) tip 20 both with and without a Saliva Ejector (SE) 24 in accordance with one embodiment of the present invention. The tip of the HVE 20 has a filter 22 container that is integral to the body. The tip is then connected to the tube attached to the vacuum pump (not shown in FIG. 2). The device also is shown in FIG. 2a with a SE tip 24 that is optionally attached on the end. Typically, a new tip is used for each patient. This allows the tip with the container to be removed from the line after the procedure is completed. The used tip is then easily, cleanly, and safely disposed of in an appropriate manner.

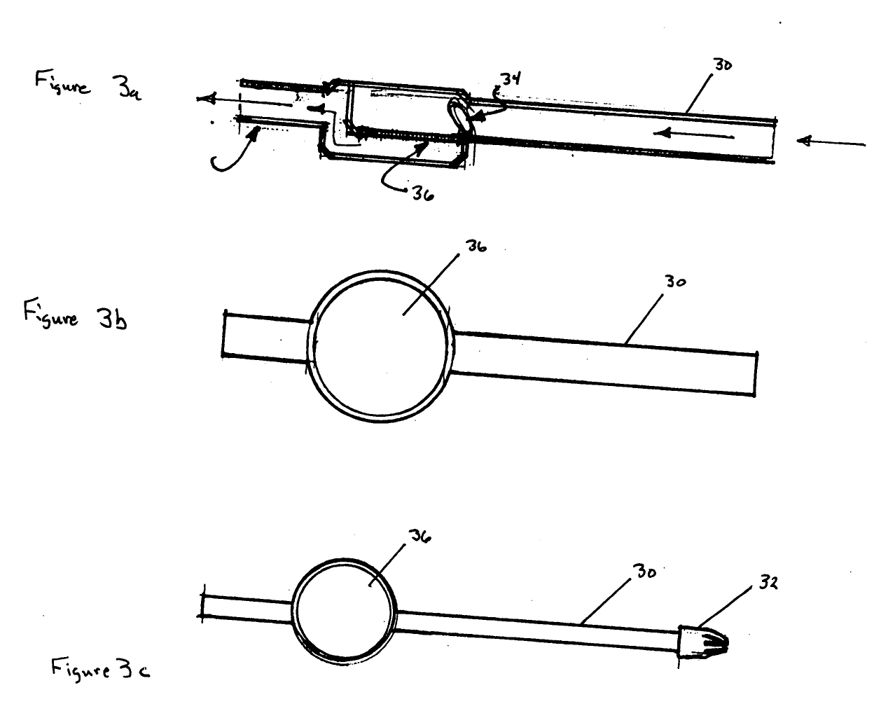

FIGS. 3a-3c show top and cross-sectional views of a High Volume Evacuation (HVE) tip 30 both with and without a Saliva Ejector (SE) 32 in accordance with one embodiment of the present invention. In this alternative embodiment, a flip valve or check valve 34 is include in the filter container 36 to prevent any backflow of filtered debris from returning to the patient's mouth.

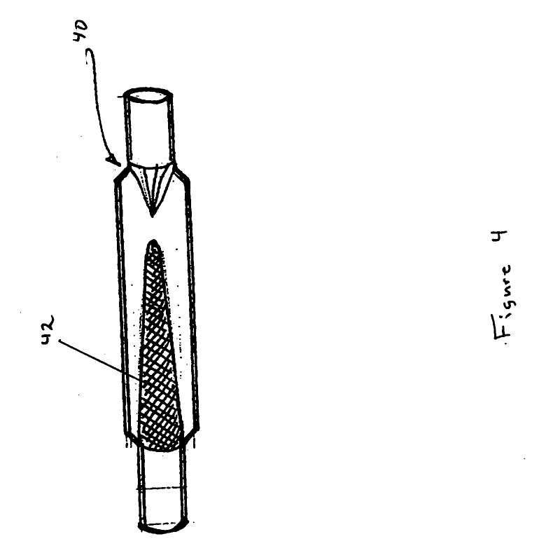

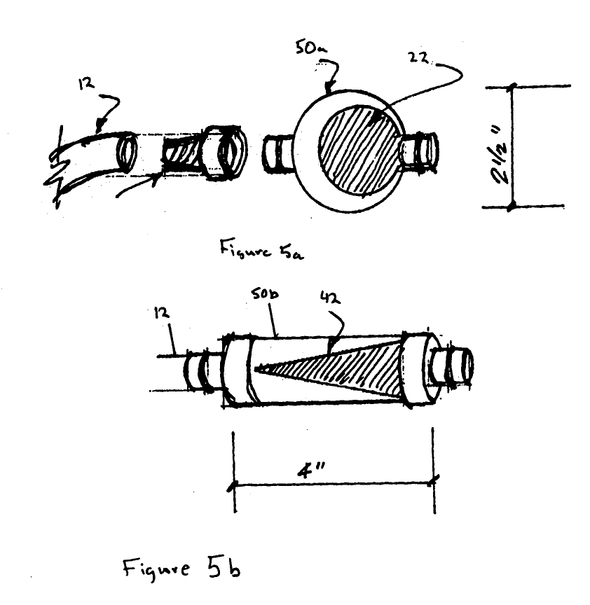

FIGS. 4 and 5 show views of other alternative embodiments of the present invention. FIG. 4 shows a cross sectional view a disposable HVE tip 40 with a conical shaped filter 42 that provides greater surface area for the filter. In other embodiments, the filter container may be a detachable cartridge that is removed from the tip for separate disposal. FIGS. 5a and 5b show cross sectional views of an example of detachable HVE filtration cartridges 50a and 50b.

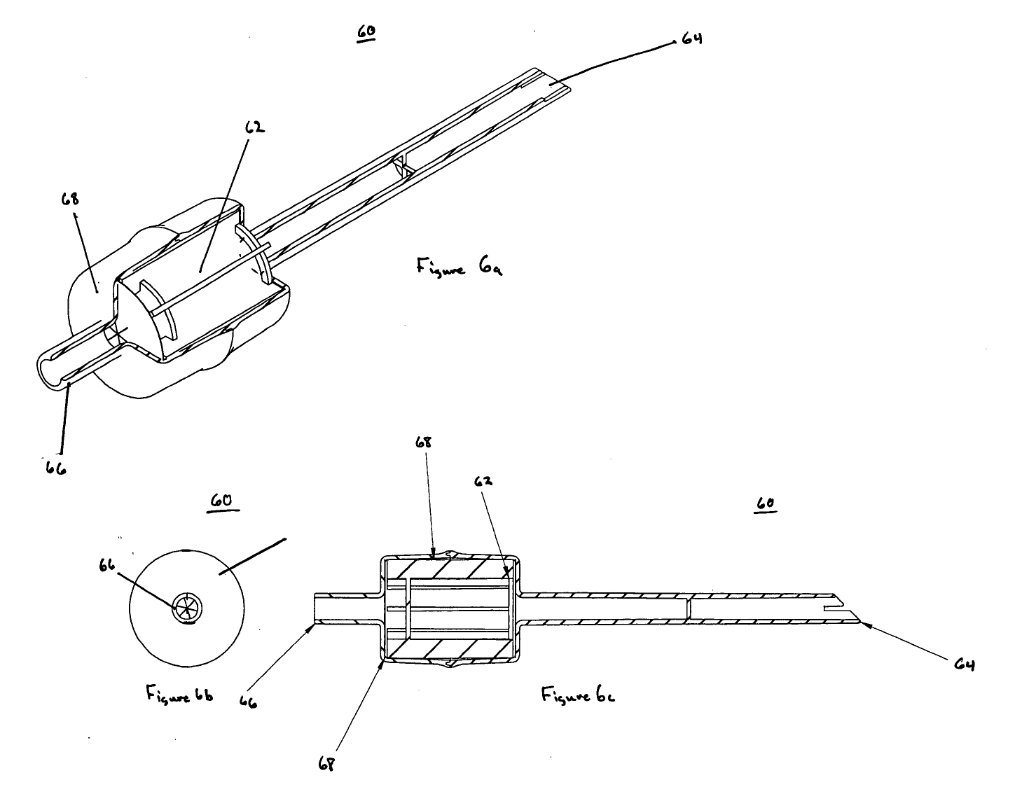

FIGS. 6a-6c show cut-away views of a High Volume Evacuation (HVE) tip 60 in accordance with other alternative embodiments of the present invention. In this embodiment, the filter 62 is completely contained within a disposable HVE tip 60. The suction end 64 of the tip is inserted into the patient's mouth. A saliva ejector (not shown) may be included if desired. The other end 66 of the tip is connected to the vacuum line (not shown) that provides suction for the invention. The filter 62 is entirely contained within the filter housing 68.

This embodiment of the invention is a disposable HVE tip with integrated filter. It is intended to be disposed after a single use. The HVE tip may include a check value to ensure retention of the dental waste within the device. The device is also flexible in the design of filters to be used. In some embodiments, the housing 68 may be opened to change a filter if needed. Other embodiments may use a sealed housing to prevent possible spillage of the filtered waste.

A conical shaped filter (as shown previously) or other suitable design may be inserted in the filter housing. However, any other suitable filter design may be used in any of the embodiments previously discussed. In some examples, the filter used in the invention should be able to capture debris greater than 30 microns in size. However, filters of different size may be used. If a filter designed to capture smaller debris (e.g., 10 microns and larger), the HVE tip may begin to lose effectiveness due to debris clogging the filter and resulting in a loss of suction. Features such as circular ridging, may be placed in the interior of the HVE tip before the filter to create a centrifugal action on the debris flow in order to dislodge any debris that gets stuck. Other features may be included to increase the effectiveness of the suction line be adding an “air venturi” to the HVE tip.

The present invention has the advantages of providing a disposable, self-contained HVE tip that catches solid dental waste. The waste is collected at the source so the chance of contamination in the waste system is minimized. Each HVE tip completely contains the waste so that the change of spillage is also minimized. Additionally, the tip may be easily disposed after a single use. Further, costs may be reduced by using a conventional HVE non-filtration tip when there is no chance of contamination from solid waste.

In summary, the advantages of the present invention include a self-contained filtration apparatus that is disposable and a filtration apparatus that minimizes contact with hazardous materials. While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. An apparatus for filtering dental solid waste, comprising:
a high volume evacuation (HVE) tip with a first end that is connected to a suction line and a second end that is inserted in a patient's mouth to remove dental waste; and
a filtration unit that is located between the first end of the HVE tip and the second end of the HVE tip, where the filtration unit retains solid dental waste within the HVE tip.

2. The apparatus of claim 1, further comprising:
a check value located between the filtration unit and the second end of the HVE tip, where the check value ensures retention of the solid dental waste within the HVE tip.

3. The apparatus of claim 1, where the filtration unit comprises:
a filter; and
a filter housing.

4. The apparatus of claim 3, where the filter is conical shaped.

5. The apparatus of claim 3, where the filter retains solid dental waste of a size greater than 30 microns.

6. The apparatus of claim 3, where the filter housing is sealed.

7. The apparatus of claim 3, where the filter housing may be opened to change the filter.

8. The apparatus of claim 3, where the filter housing may be opened to clean the filter.

9. An apparatus for filtering dental solid waste, comprising:
a high volume evacuation (HVE) tip with a first end that is connected to a suction line and a second end that is inserted in a patient's mouth to remove dental waste; and
means for filtering and retaining dental solid waste within the HVE tip.
